(19) United States
(12) Patent Application Publication
(10) Pub. No.: US 2026/0071530 A1
(43) Pub. Date: Mar. 12, 2026

(54) TECHNIQUES FOR ENHANCING PROPPANT DISTRIBUTION

(71) Applicant: Schlumberger Technology Corporation, Sugar Land, TX (US)

(72) Inventors: Konstantin Viktorovich Vidma, Sugar Land, TX (US); Christopher S. Daeffler, Sugar Land, TX (US); Melissa Chia Mei Teoh, Paris (FR)

(21) Appl. No.: 19/324,505

(22) Filed: Sep. 10, 2025

Related U.S. Application Data
(60) Provisional application No. 63/693,017, filed on Sep. 10, 2024.

(51) Int. Cl. E21B 43/267; C09K 8/66

(52) U.S. Cl. CPC E21B 43/267; C09K 8/665

(57) ABSTRACT

Certain embodiments of the present disclosure are directed to techniques for creating a filler material within a slickwater slurry. The filler material is generated by adding a cationic additive to the slickwater slurry. The cationic additive can be introduced to the slurry either before, after, or simultaneously with the proppant or friction reducer. Upon addition and mixing with the friction reducer, the cationic additive reacts due to electrostatic attraction, forming gel-like substances or agglomerates. This process, which may be termed complex coacervation, agglomeration, or aggregation, may entrap proppant particles during formation, with proppant particles possibly being trapped within these agglomerates or aggregates. The operation then proceeds as a slickwater treatment. After the proppant is delivered into the fracture and subsequently transported and settled, the agglomerates act as fillers within the proppant pack, thereby reducing its bulk density.

### CROSS-REFERENCE TO RELATED APPLICATIONS

The present application claims priority to and the benefit of U.S. Provisional Patent Application Ser. No. 63/693,017 titled “TECHNIQUES FOR ENHANCING PROPPANT DISTRIBUTION” filed Sep. 10, 2024, the disclosure of which is incorporated herein by reference in its entirety.

### BACKGROUND

The present disclosure generally relates to techniques for enhancing proppant distribution within a fracture system.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

Slickwater fracturing can be applied in unconventional reservoir applications. Typically, slickwater fracturing is used in multistage fracturing of horizontal or deviated wells. However, slickwater fracturing can also be effectively employed in vertical wells. In multistage fracturing, stimulation is performed sequentially, one stage after another.

During each stage of stimulation, fracturing fluid is pumped downhole at a pressure exceeding the formation's fracture pressure. This process creates a fracture or a system of fractures with varying levels of complexity. Slickwater operations generally involve a mixture of water, friction reducer (FR), and other additives. The friction reducers commonly used are anionic polymers, such as polyacrylamides or copolymers of acrylamide. Other polymers, though less frequently used, include cationic polyacrylamide, copolymers of acrylamide/DADMAC (diallyldimethylammonium chloride), nonionic polyacrylamide, non-ionic polysaccharides (such as guar gum), and polyethylene oxide (PEO).

At a certain point during the operation, a proppant (e.g., sand) is introduced into the fluid. The fluid stages containing the proppant are then pumped downhole, and during this phase, the fracture or system of fractures continues to expand. The proppant is transported into the fracture through a mechanism known as dune transport, where the proppant forms dune-like structures as it moves through the fracture, typically along the upper part of the dune, driven by the flow of slickwater, a low-viscosity fluid.

In this type of operation, the proppant effectively fills the bottom part of the fracture system, forming a dense pack with a bulk density characteristic of a random pack of the corresponding proppant. Note that, real fractures are not planar; they include bends, roughness, edges, cliffs, and other irregularities that may affect proppant distribution during and after transport. Despite these complexities, the general concept of the process remains consistent.

Once sufficient proppant has been placed into the fracture system, pumping is halted, the zone is isolated, and the fracture is allowed to close. During this time, stimulation and other operations are typically performed on other stages of the well. After complete fracture closure, which may take from hours to days or even weeks, the well may be put on flowback and production or on injection mode, depending on its intended purpose.

### SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure are directed to techniques for creating a filler material within a slickwater slurry. The filler material is generated by adding a cationic additive to the slickwater slurry. The cationic additive can be introduced to the slurry either before, after, or simultaneously with the proppant or friction reducer. Upon addition and mixing with the friction reducer, the cationic additive reacts due to electrostatic attraction, forming gel-like substances or agglomerates. This process, which may be termed complex coacervation, agglomeration, or aggregation, may entrap proppant particles during formation, with proppant particles possibly being trapped within these agglomerates or aggregates.

The operation then proceeds as a slickwater treatment. After the proppant is delivered into the fracture and subsequently transported and settled, the agglomerates act as fillers within the proppant pack, thereby reducing its bulk density. This can also be described as increasing the height of the proppant pack or proppant bank for a given mass of proppant.

In one embodiment, the filler material functions such that, when the fracturing and all subsequent stages of the process are complete, the higher proppant bank results in better reservoir coverage with a similar or even reduced total mass of proppant pumped per stage.

In another embodiment, the total volume of proppant per stage can be reduced, enabling cost, logistics, and emission savings while maintaining similar or enhanced reservoir contact.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings, in which:

FIG. 1 is a schematic representation of a fracking system, in accordance with embodiments of the present disclosure;

FIGS. 2A-2C are a series of photographs illustrating settling results after exposing a slurry to a shear rate of 1600 sec⁻¹ for 3 minutes, in accordance with embodiments of the present disclosure;

FIGS. 3A-3C are a series of photographs showing settled sand banks formed after a slurry was pumped through a 1 mm slot a controlled rate, in accordance with embodiments of the present disclosure;

FIGS. 4A and 4B are a series of photographs demonstrating sand pack stability after exposure to 300° F. and 160 psi for 4 days, in accordance with embodiments of the present disclosure;

FIG. 5 is a graph of settled sand coverage area as a function of cationic additive and sand concentration after pumping the slurry through a 1 mm slot at a rate that ensured complete settling in a single run, in accordance with embodiments of the present disclosure;

FIG. 6 is a graph of proppant pack heights at various fluid ionic strengths, in accordance with embodiments of the present disclosure;

FIGS. 7A-7D are a series of photographs demonstrating sand pack stability after exposure to temperature and pressure, in accordance with embodiments of the present disclosure;

FIG. 8 is a graph of regained conductivity, in accordance with embodiments of the present disclosure;

FIG. 9 is a graph of friction reduction performance, in accordance with embodiments of the present disclosure; and

FIG. 10 is a series of graphs of fluid viscosity, in accordance with embodiments of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.” As used herein, the terms “up” and “down,” “uphole” and “downhole”, “upper” and “lower,” “top” and “bottom,” and other like terms indicating relative positions to a given point or element are utilized to more clearly describe some elements. Commonly, these terms relate to a reference point as the surface from which drilling operations are initiated as being the top (e.g., uphole or upper) point and the total depth along the drilling axis being the lowest (e.g., downhole or lower) point, whether the well (e.g., wellbore, borehole) is vertical, horizontal or slanted relative to the surface.

In addition, as used herein, the terms “real time”, “real-time”, or “substantially real time” may be used interchangeably and are intended to described operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic” and “automated” are intended to describe operations that are performed or caused to be performed, for example, by a processing system (i.e., solely by the processing system, without human intervention). In addition, as used herein, the term “approximately equal to” may be used to mean values that are relatively close to each other (e.g., within 5%, within 2%, within 1%, within 0.5%, or even closer, of each other).

As mentioned above, slickwater fracturing can be applied in unconventional reservoir applications. Slickwater operations generally involve a mixture of water, friction reducer (FR), and other additives.

Embodiments of the present disclosure are directed to techniques for creating a filler material within a slickwater slurry. The filler material is generated by adding a cationic additive to the slickwater slurry. The cationic additive can be introduced to the slurry either before, after, or simultaneously with the proppant or friction reducer. Upon addition and mixing with the friction reducer, the cationic additive reacts due to electrostatic attraction, forming gel-like substances, agglomerates, or filler material. As used herein, the terms gel-like substance, agglomerate, and filler material may refer to the polymer generated based on the mixing of the cationic additive (e.g., cationic polymer) and the anionic polymer. This process, which may be termed complex coacervation, agglomeration, or aggregation, may entrap proppant particles during formation, with proppant particles possibly being trapped within these agglomerates or aggregates.

The operation then proceeds as a slickwater treatment. After the proppant is delivered into the fracture and subsequently transported and settled, the agglomerates act as fillers within the proppant pack, thereby reducing its bulk density. This can also be described as increasing the height of the proppant pack or proppant bank for a given mass of proppant.

In one embodiment, the filler material functions such that, when the fracturing and all subsequent stages of the process are complete, the higher proppant bank results in better reservoir coverage with a similar or even reduced total mass of proppant pumped per stage.

In another embodiment, the total volume of proppant per stage can be reduced, enabling cost, logistics, and emission savings while maintaining similar or enhanced reservoir contact.

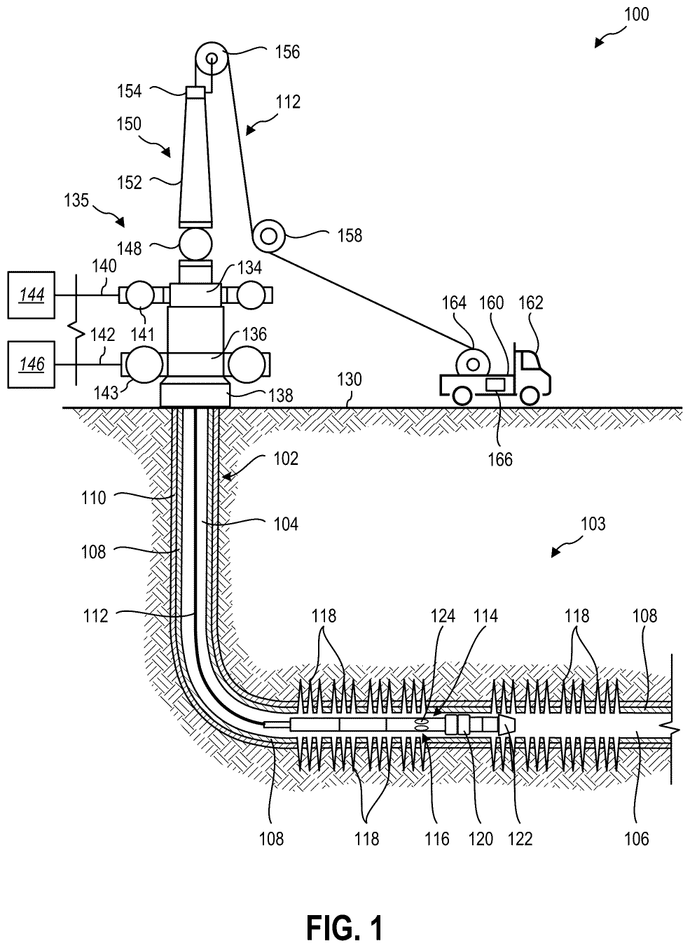

Referring to FIG. 1, a fracking system 100 may be configured for performing fracking operations in a wellbore 102 and an earth formation 103 through which the wellbore 102 extends. The fracking system 100 provides a means for creating openings that facilitate fluid communication between the wellbore 102 and surrounding geological structures. The earth formation 103 may include various rock types and geological layers that contain hydrocarbons or other subsurface fluids. The wellbore 102 may be formed through drilling operations that penetrate the earth formation 103 to access hydrocarbon-bearing zones at various depths and orientations.

The wellbore 102 may include a vertical portion 104 and a horizontal portion 106 that extends laterally through the earth formation 103. The vertical portion 104 may extend downward from the surface through multiple geological layers, while the horizontal portion 106 may be oriented substantially parallel to bedding planes or other geological features within the earth formation 103. This configuration allows for enhanced contact with hydrocarbon-bearing zones and may improve production efficiency. The transition between the vertical portion 104 and the horizontal portion 106 may occur at various depths depending on the target formation characteristics and drilling objectives.

The wellbore 102 may be lined with casing 108 that provides structural integrity and isolation between different zones within the earth formation 103. The casing 108 may include steel tubulars or other materials that resist corrosion and maintain wellbore stability under downhole conditions. The casing 108 may extend through both the vertical portion 104 and/or the horizontal portion 106, providing a continuous barrier between the wellbore fluids and the surrounding earth formation 103. Multiple casing strings of different diameters may be installed at various depths to accommodate different operational requirements and formation characteristics.

Cement 110 may be positioned in an annular space between the casing 108 and the earth formation 103 to provide zonal isolation and structural support. The cement 110 may include Portland cement or other cementing materials that cure to form a solid barrier. The cement 110 may prevent fluid migration between different zones within the earth formation 103 and may provide additional structural support for the casing 108. The cement 110 may extend along portions of both the vertical portion 104 and/or the horizontal portion 106, depending on the completion design and regulatory requirements. The a perforation system may be configured to penetrate through both the casing 108 and the cement 110 to establish fluid communication with the earth formation 103.

A wireline 112 (or other conveyance or intervention system, such as coiled tubing) may extend into the wellbore 102 to convey downhole equipment and facilitate various wellbore operations. The wireline 112 may include one or more electrical cables configured to transmit data and signals to downhole components, enabling real-time communication and control during operations. The wireline 112 may include a protective sheath or jacket disposed around internal portions to provide protection against wellbore fluids and mechanical wear. In some embodiments, the wireline 112 may include a steel wire armored cable that provides structural strength and electrical conductivity for downhole operations. The protective sheath may be formed of fluid-resistant materials such as epoxy compounds that resist degradation from exposure to various wellbore fluids and chemicals.

The wireline 112 may carry a bottomhole assembly 114 that includes various tools and components for performing downhole operations within the wellbore 102. The bottomhole assembly 114 may be configured to perform multiple functions during a single trip into the wellbore 102, thereby improving operational efficiency and reducing the time required for completion activities. The bottomhole assembly 114 may include components that are selectively activated or operated based on downhole conditions or surface commands transmitted through the wireline 112. In some embodiments, the bottomhole assembly 114 may be positioned at predetermined locations within the wellbore 102 using depth control systems that monitor the position of the assembly relative to target zones within the earth formation 103.

The bottomhole assembly 114 may include a perforating gun 116 configured to create openings through the casing 108 and cement 110 to establish fluid communication with the earth formation 103. The perforating gun 116 may contain shaped charges that are designed to penetrate through multiple barriers including the casing 108, the cement 110, and portions of the earth formation 103 surrounding the wellbore 102. The perforating gun 116 may be configured to fire the shaped charges at predetermined locations along the wellbore 102 to create perforations 118 that extend from the wellbore 102 into the earth formation 103. The perforations 118 may provide pathways for fluid communication between the wellbore 102 and hydrocarbon-bearing zones within the earth formation 103, enabling the flow of formation fluids into the wellbore 102 for production or the injection of treatment fluids into the formation.

The perforating gun 116 may include spaced perforations 124 through which the shaped charges are discharged into the casing 108 and surrounding materials. The spaced perforations 124 may be positioned at predetermined intervals along the length of the perforating gun 116 to provide controlled placement of the shaped charges. In some embodiments, the spaced perforations 124 may be oriented at specific angles relative to the axis of the perforating gun 116 to direct the shaped charges in desired directions within the earth formation 103. The spacing and orientation of the spaced perforations 124 may be selected based on formation characteristics, completion objectives, and the desired pattern of perforations 118 to be created in the wellbore 102. The shaped charges may be activated simultaneously or in sequence to create the perforations 118 through the casing 108, cement 110, and into the earth formation 103.

The bottomhole assembly 114 may further include a plug setting tool 120 configured to place a plug 122 within the wellbore 102 to provide zonal isolation during completion operations. The plug setting tool 120 may be designed to transport the plug 122 to a predetermined location within the wellbore 102 and deploy the plug 122 to create a seal against the inner surface of the casing 108. The plug 122 may include expandable elements that engage with the casing 108 to prevent fluid flow past the plug 122 location. In some embodiments, the plug 122 may include scaling elements such as elastomeric packers that conform to the inner surface of the casing 108 to provide effective scaling under downhole pressure and temperature conditions. The plug setting tool 120 may include mechanisms for expanding the plug 122 and securing the plug 122 in position within the wellbore 102.

As further shown in FIG. 1, the plug 122 may be positioned to isolate previously perforated sections of the wellbore 102 from subsequent completion operations. The plug 122 may be placed uphole of existing perforations 118 to prevent treatment fluids from entering previously completed zones during fracturing operations in new zones. The plug setting tool 120 may be activated through signals transmitted via the wireline 112 to deploy the plug 122 at the desired location. Once activated, the plug setting tool 120 may cause the plug 122 to expand radially and engage with the inner surface of the casing 108 to form a pressure-tight scal. The plug 122 may be designed to withstand differential pressures encountered during subsequent fracturing operations while maintaining isolation between different zones within the wellbore 102. The placement of the plug 122 enables staged completion operations where different sections of the wellbore 102 may be treated independently to optimize hydrocarbon recovery from the earth formation 103.

At a surface 130, the wellbore 102 may be equipped with various control systems and equipment that facilitate fluid injection and production operations. A fluid flow control system 135 may be positioned at the surface 130 to direct and control the flow of treatment fluids into the wellbore 102 and to manage the flow of formation fluids out of the wellbore 102 during production operations. The fluid flow control system 135 may include multiple components including flow control valves, spools, flow crosses, and fittings that work together to provide operational control over fluid movement. A first flow control device 134 and a second flow control device 136 may be incorporated within the fluid flow control system 135 to provide selective control over different fluid streams or operational modes. The first flow control device 134 and the second flow control device 136 may each include valve assemblies that can be opened or closed to permit or prevent fluid flow through designated pathways. In some embodiments, the fluid flow control system 135 may include blow-out preventer components that provide safety control by preventing uncontrolled flow of formation fluids from the wellbore 102 to the surface 130.

The fluid flow control system 135 may be coupled to a wellhead 138 that terminates the wellbore 102 at the surface 130 and provides a connection point for various surface equipment and fluid handling systems. A first fluid conduit 140 may be connected to the first flow control device 134 through a first valve 141 to enable selective fluid communication between external fluid sources and the wellbore 102. The first fluid conduit 140 may be configured to transport various fluids including pumpdown fluids, acid treatments, stimulation fluids, completion fluids, fracturing fluids, or corrosion inhibitor compositions to the wellbore 102 as operational requirements dictate. A second fluid conduit 142 may be connected to the second flow control device 136 through a second valve 143 to provide an additional pathway for fluid delivery or to enable simultaneous injection of different fluid types. A first pump 144 may be operatively connected to the first fluid conduit 140 to provide the pressure and flow rate needed to deliver fluids through the first flow control device 134 and into the wellbore 102. A second pump 146 may be operatively connected to the second fluid conduit 142 to provide independent pumping capability for fluids delivered through the second flow control device 136. The first pump 144 and the second pump 146 may be configured to operate at different pressures and flow rates to accommodate various operational requirements including fracturing operations that may utilize the disclosed foam fluid compositions.

An access valve 148 may be incorporated within the fluid flow control system 135 to facilitate vertical access to the wellbore 102 by the bottomhole assembly 114 or other downhole tools while maintaining pressure control during operations. A sealing and alignment assembly 150 may be operatively coupled to the access valve 148 to provide sealing around the wireline 112 during deployment, conveyance, intervention, and other wellsite operations performed while the wireline 112 extends within the wellbore 102. The sealing and alignment assembly 150 may include a lock chamber 152 mounted above the access valve 148 that functions as a lubricator, airlock, or riser to enable safe insertion and removal of downhole equipment under pressure conditions. A stuffing box 154 may be configured within the sealing and alignment assembly 150 to create a seal around the outer surface of the wireline 112 at an upper portion of the lock chamber 152, where the stuffing box 154 may utilize annular packings applied around the surface of the wireline 112 or may inject sealing fluids between the outer surface of the wireline 112 and an inner wall of the stuffing box 154. A pulley 156 may be positioned to guide the wireline 112 into the stuffing box 154, while a guide pulley 158 may direct the wireline 112 between the pulley 156 and a conveyance device 160 such as a winch system that controls the movement of the wireline 112 within the wellbore 102. The wireline 112 may be supplied from a drum 164 that may be carried by a vehicle 162 along with the conveyance device 160, where the drum 164 may be rotated by an actuator 166 that may include an electric motor, hydraulic motor, or other means for selectively unwinding and winding the wireline 112 around the drum 164 while applying adjustable tensile forces to control the position and movement of the bottomhole assembly 114 within the wellbore 102.

During fracking operations, one or both of the first pump 144 or second pump 146 may pump a fracking fluid into the wellbore 102. For example, the plug 122 may be set to isolate one or more of the sections or zones of the wellbore 102, including a section of one or more perforations 118 through the casing 108 and cement 110. The fracking fluid may be pumped such that it may flow into the earth formation 103 through the perforations 118. The first pump 144 and/or second pump 146 may pressurize the fluid past a fracture pressure of the earth formation 103, thereby causing fractures to form in the earth formation 103. Based on the pressures experienced in the earth formation 103, the fractures may form vertically, horizontally, perpendicular to the orientation of the wellbore 102, parallel to the orientation of the wellbore 102, perpendicular to the stratigraphic orientation of the earth formation 103, parallel to the stratigraphic orientation of the earth formation 103, or in any other direction or orientation.

The fractures may create fluid flow paths for fluids in the earth formation 103 to enter the wellbore 102. In some situations, after fracking, the fractures may close. To prop the fractures open and facilitate fluid flow into the wellbore 102, the fracking fluid may include a slurry of proppant. The proppant may include grains of a hard material that may prop open the fractures as the fractures close. Further, in some situations, the fracking fluid may include one or more additives to facilitate the flow of the fracking fluid through the wellbore 102 and into the earth formation 103. For example, the fracking fluid may include a slickwater slurry, which may include a friction reducer that may reduce the impact of friction of the slickwater slurry in the wellbore 102, thereby reducing the pressure used to pump the slickwater slurry to the target location.

During fracking operations, the proppant in the slickwater slurry may flow into the fractures generated during fracking. The extent into the fracture that the proppant may flow may be based on the amount of proppant in the slickwater slurry, the size of the proppant particles, the flow rate of the slickwater slurry, or other factors.

In accordance with at least one embodiment of the present disclosure, a cationic additive may be added to the slickwater slurry. As discussed herein, the cationic additive may react with ionic polymers (such as the friction reducer) in the slickwater slurry to generate agglomerates. The agglomerates may include one or more particles of the proppant. As shown in the Examples provided herein, the agglomerates may increase the volume of the proppant distribution. In this manner, the same amount of proppant may distribute further in the fractures and/or a lessor amount of proppant may be used to provide the same volume of fracture coverage.

In some embodiments, the gel agglomerate formed by the reaction of the cationic additive with the friction reducer may degrade downhole to facilitate fluid flow from the earth formation 103, through the fractures, and into the wellbore 102. For example, the gel of the agglomerate may break down in the presence of one or more conditions. For example, the gel may be broken down or dissolved based on contact with a saline water. In some examples, the gel may be broken down or dissolved based on contact with oil. In some examples, the gel may be broken down or dissolved based on prolonged exposure to the temperature and pressure of the earth formation 103.

### Cationic Additive Chemical Identity

The cationic additive consists of a polymer with non-limiting examples from the following classes: Polyaziridines, more particularly: aziridine, homopolymer, reaction products with epichlorohydrin and polyethylene glycol, acetates; Polyethylene iminoacetate; Modified polyethylencimines (PEIs), specifically: PEGylated Polyethyleneimine (PEG-PEI), alkylated polyethylencimine, cross-linked polyethyleneimine, phosphorylated polyethylencimine. The described cationic additives may be selected or formulated to form the agglomerates of the present disclosure. For example, the described cationic additives may be selected and formulated to generate, upon mixing with the friction reducer in the slurry, agglomerates.

In accordance with at least one embodiment of the present disclosure, the agglomerates may be agglomerated with one or more particles of the proppant. For example, the proppant may include sand particles. When the cationic additive is mixed with a slurry including the proppant sand particles, the cationic additive may react to form the agglomerates. As the agglomerates form, one or more sand particles may be agglomerated with the agglomerates. For example, a sand particle may become at least partially surrounded by the resulting agglomerate. In some examples, at least a portion of the sand particle may be surrounded by the agglomerate. In some examples, the agglomerate may form around and adhere to the sand particles. In some examples, the shape of the sand particles may facilitate the retention of the sand particles in the agglomerate.

In some embodiments, the agglomerates may include any number of sand particles. In some embodiments, the number of sand particles may be in a range having an upper value, a lower value, or upper and lower values including any of 1, 2, 3, 4, 5, 6, 7, 8, 9, 10, 25, 50, 75, 100, 500, 1,000, 5,000, 10,000, 50,000, 100,000, 150,000 or any value therebetween. For example, the number of sand particles may be greater than 1. In another example, the number of sand particles may be less than 150,000. In yet other examples, the number of sand particles may be any value in a range between 1 and 150,000.

In some embodiments, the volume percent (vol %) of sand particles in the agglomerates may be in a range having an upper value, a lower value, or upper and lower values including any of 0.1%, 1%, 5%, 10%, 20%, 30%, 40%, 50%, 60%, 70%, or any value therebetween. For example, the vol % may be greater than 0.1%. In another example, the vol % may be less than 70%. In yet other examples, the vol % may be any value in a range between 10% and 70%.

In some embodiments, the average agglomerate size of the agglomerates formed by the reaction of the cationic additive and the anionic friction reducer may be in a range having an upper value, a lower value, or upper and lower values including any of 0.1 mm, 0.2 mm, 0.3 mm, 0.4 mm, 0.5 mm, 0.6 mm, 0.7 mm, 0.8 mm, 0.9 mm, 1.0 mm, 1.5 mm, 2.0 mm, 2.5 mm, 5.0 mm, 10 mm, or any value therebetween. For example, the average agglomerate size may be greater than 0.1 mm. In some examples, the average agglomerate size may be greater than the size of the proppant. In another example, the average agglomerate size may be less than 10.0 mm. In yet other examples, the average agglomerate size may be any value in a range between 0.1 mm and 10.0 mm.

While visible agglomerates almost certainly result in a reduction of sand pack bulk density. However, it should be understood that a bulk density reduction can also occur when no agglomerates are observed visually. This indicates that a “fluffiness effect” may occur through the formation of very small agglomerates-on the order of individual grain size—that are difficult to detect by eye but still influence packing.

In some embodiments, the cationic additive may have a molecular weight in a range having an upper value, a lower value, or upper and lower values including any of 10,000 Daltons 50,000 Daltons, 100,000 Daltons, 250,000 Daltons, 500,000 Daltons, 750,000 Daltons, 1,000,000 Daltons, 1,500,000 Daltons, 2,000,000 Daltons, 2,500,000 Daltons, 3,000,000 Daltons, 3,500,000 Daltons, 4,000,000 Daltons, 4,500,000 Daltons, 5,000,000 Daltons, or any value therebetween. For example, the molecular weight may be greater than 50,000 Daltons. In another example, the molecular weight may be less than 5,000,000 Daltons. In yet other examples, the molecular weight may be any value in a range between 50,000 Daltons and 5,000,000 Daltons.

In some embodiments, the cationic additive may be added to the slurry at concentrations in a range having an upper value, a lower value, or upper and lower values including any of 0.002, 0.004 g/L, 0.01 g/L, 0.025 g/L, 0.05 g/L, 0.075 g/L, 0.1 g/L, 0.15 g/L, 0.2 g/L, 0.25 g/L, 0.3 g/L, 0.4 g/L, 0.5 g/L, or any value therebetween. For example, the concentration may be greater than 0.002 g/L. In another example, the concentration may be less than 0.5 g/L. In yet other examples, the concentration may be any value in a range between 0.004 g/L and 0.5 g/L. In some examples, the concentration may be any value in a range of between 0.004 g/L to 0.1 g/L.

In some embodiments, the concentration of the anionic friction reducer may be in a range having an upper value, a lower value, or upper and lower values including any of 0.012 g/L, 0.05 g/L, 0.1 g/L, 0.2 g/L, 0.3 g/L, 0.4 g/L, 0.5 g/L, 0.75 g/L, 1.0 g/L, 1.5 g/L, 2.0 g/L, 2.4 g/L, 3 g/L, 4 g/L, 5 g/L, 6 g/L, or any value therebetween. For example, the concentration may be greater than 0.012 g/L. In another example, the concentration may be less than 6 g/L. In yet other examples, the concentration may be any value in a range between 0.012 g/L and 6 g/L.

In some embodiments, the cationic additive may be added to the slurry without a change in the anionic friction reducer concentration. For example, and without desiring to be bound by theory, the consumption of the anionic friction reducer may be minimal, or may have limited or unnoticeable impact on the performance of the slickwater slurry.

In some embodiments, the cationic additive can be added at any time during the mixing of the slurry. For example, the cationic additive may be added simultaneously with the addition of the friction reducer. In some examples, the cationic additive may be added after the addition of the friction reducer. For example, the cationic additive may be added after the friction reducer has been fully hydrated, wetted, dissolved or otherwise mixed with the slurry. This may facilitate the most efficient or quickest formation of the agglomerates. In some examples, the cationic additive may be added before the friction reducer.

In some embodiments, the cationic additive may be mixed into the slurry at the surface. For example, the cationic additive may be mixed into the slickwater slurry at the surface prior to pumping the slickwater slurry downhole. In some embodiments, the cationic additive may be mixed into the slurry downhole. For example, the cationic additive may be pumped downhole via a separate line and mixed prior to pressurizing the slickwater slurry for fracking.

In some embodiments, the filler material (e.g., the agglomerates), may retain functionality upon exposure to shear forces applied to the slickwater slurry during pumping and fracking operations. For example, the individual agglomerate particles may maintain cohesion with the proppant particles upon exposure to shear forces applied to the slickwater slurry during pumping and fracking operations. As a specific, non-limiting example, the filler material may retain functionality after exposure to a shear rate of up to 1,600 sec⁻¹ for at least three minutes.

In some embodiments, the filler material may be temperature resistant to temperatures that may be experienced during the fracking process. For example, as discussed herein, the filler material may be temperature resistant at downhole temperatures for the closing period of the fractures. In unconventional wells, the closing period may be hours or days. As a specific, non-limiting example, after being formed and pumped downhole, the filler material maintains functionality when exposed to temperatures up to 300° F. for at least four days.

The proppant may include any proppant used during fracking processes. For example, types of proppant may include, without limitation, sand, ceramic proppant, resin-coated proppant, sand, any other suitable type of proppant, and combinations thereof.

The proppant may have a specific gravity that exceeds that of the carrier fluid (including the specific gravity of the resulting agglomerates). In some embodiments, the specific gravity may be in a range having an upper value, a lower value, or upper and lower values including any of 2.0, 2.25, 2.5, 2.75, 3.0, 3.25, 3.5, 3.75, 4.0, 4.25, 4.5, or any value therebetween. For example, the specific gravity may be greater than 2.0. In another example, the specific gravity may be less than 4.5. In yet other examples, the specific gravity may be any value in a range between 2.0 and 4.5. In some embodiments, during slickwater fracturing, the proppant may include sand having a specific gravity of between 2.5 and 2.7.

In some embodiments, the proppant size may be in a range having an upper value, a lower value, or upper and lower values including any of 37 microns (400 mesh), 44 microns (325 mesh), 53 microns (270 mesh), 63 microns (230 mesh), 75 microns (200 mesh), 90 microns (170 mesh), 105 microns (140 mesh), 125 microns (120 mesh), 150 microns (100 mesh), 212 microns (70 mesh), 250 microns (60 mesh), 300 microns (50 mesh), 425 microns (40 mesh), 600 microns (30 mesh), 1,700 microns (10 mesh), or any value therebetween. For example, the proppant size may be greater than 37 microns (400 mesh). In another example, the proppant size may be less than 1,700 microns (10 mesh). In some embodiments, 100-mesh sand is typically used. In some embodiments, a mesh combination may be utilized, such as 30/50 mesh, 30/70 mesh, 40/70 mesh, or 70/140.

In some embodiments, the proppant concentration may be in a range having an upper value, a lower value, or upper and lower values including any of 12 g/L added fluid, 50 g/L, 100 g/L, 200 g/L, 300 g/L, 400 g/L, 500 g/L, 600 g/L, 700 g/L, 800 g/L, 900 g/L, 1,000 g/L, 1,100 g/L, 1,200 g/L, or any value therebetween. For example, the proppant concentration may be greater than 12 g/L. In another example, the proppant concentration may be less than 1,200 g/L. In yet other examples, the proppant concentration may be any value in a range between 12 g/L and 1,200 g/L. As a specific, non-limiting example, the proppant concentration may be between 60 and 240 grams per liter of added fluid.

The embodiments described herein have been tested and are effective in the presence of other additives besides friction reducer, proppant, and cationic additive. These include, but are not limited to, biocides, surfactants, and clay stabilizers. The cationic additive, before or after reaction with the ionic friction reducer, has not been shown to negatively impact other additives to a slickwater slurry.

In some embodiments, the base fluid salinity may be up to 2.0 M. Laboratory tests have explored range of salinities up to 0.67 M, as further described below.

### EXAMPLES

The examples below demonstrate the efficacy and robustness of the filler material at a range of conditions.

### Example 1: Formation of Filler Material and Its Resistance to Shear Rate

Example 1 illustrates the creation of a filler material and evaluates its shear resistance under controlled conditions. A slurry containing an anionic friction reducer, cationic additive and 100-mesh sand was prepared and subjected to a shear rate of 1,600 sec⁻¹ for 3 minutes. The slurry was then placed in a vertical glass cylinder to allow the sand to settle. The results, including the comparative effectiveness of the filler material, are shown in FIG. 1.

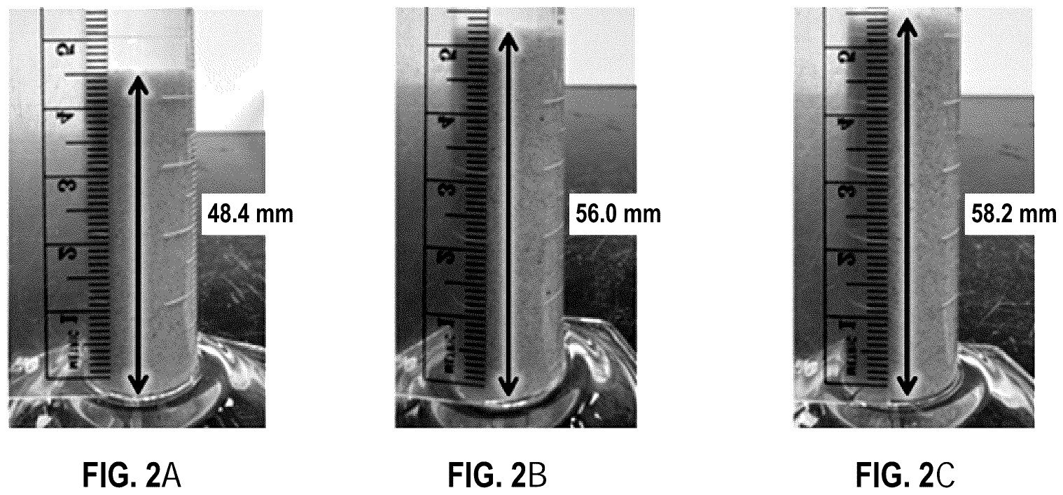

FIG. 2A is the baseline (i.e., without cationic additive), which includes anionic friction reducer mixed at 0.40 g/L and a 100-mesh sand slurry. FIG. 2B is anionic friction reducer mixed at 0.40 g/L and cationic additive (mixed at 0.022 g/L) and a 100-mesh sand slurry. FIG. 2B illustrates a 15.8% increase in settled sand height compared to the baseline. FIG. 2C is similar to FIG. 2B but with doubled cationic additive concentration (e.g., 0.44 g/L), resulting in a 20.3% increase in settled sand height compared to the baseline.

As shown in FIG. 2B, the test with 0.022 g/l of cationic additive resulted in a 15.8% increase in settled sand height compared to the baseline (i.e., without cationic additive), shown in FIG. 2A. When the cationic additive concentration was increased to 0.044 g/l (as shown in FIG. 2C), the settled sand height increased by 20.3% compared to the baseline.

Test conditions and procedure for Example 1: the following steps describe the shear rate resistance test procedure.

1. Prepare 1 L of friction reducer solution by mixing 0.4 g of anionic friction reducer using an overhead mixer with a 3-blade marine impeller at a 1000 RPM for approximately 1 minute.

2. Prepare 50 ml of cationic additive solution by adding 0.66 g of the cationic additive in 50 ml of tap water, and mix well by stirring.

3. Measure out 60 ml of anionic fracture reducer solution, and pour it into a 100 ml beaker.

4. Start mixing the solution using an overhead mixer with a 0.75″ 3-blade marine impeller at 2300 RPM.

5. Measure out desired amount of 100 mesh sand, and add 0.1 ml (0.022 g/l) or 0.2 ml (0.044 g/l) of the cationic additive solution on the top of the sand, and quickly add it into the friction reducer solution.

6. Continue mixing for approximately 30 seconds, stop mixing, transfer the slurry into a rheometer geometry test setup, then mix the slurry at an approximate RPM to generate 1600 s⁻¹ for three minutes.

7. Transfer all the sand and appropriate amount of fluid into a 25-ml graduated cylinder, let it settle for 30 minutes, and measure the final sand pack height in millimeters.

8. Repeat steps 3-7 to prepare a baseline sample without adding cationic additive.

### Example 2: Formation of a Filler Material and Subsequent Pumping through a 1 mm Slot

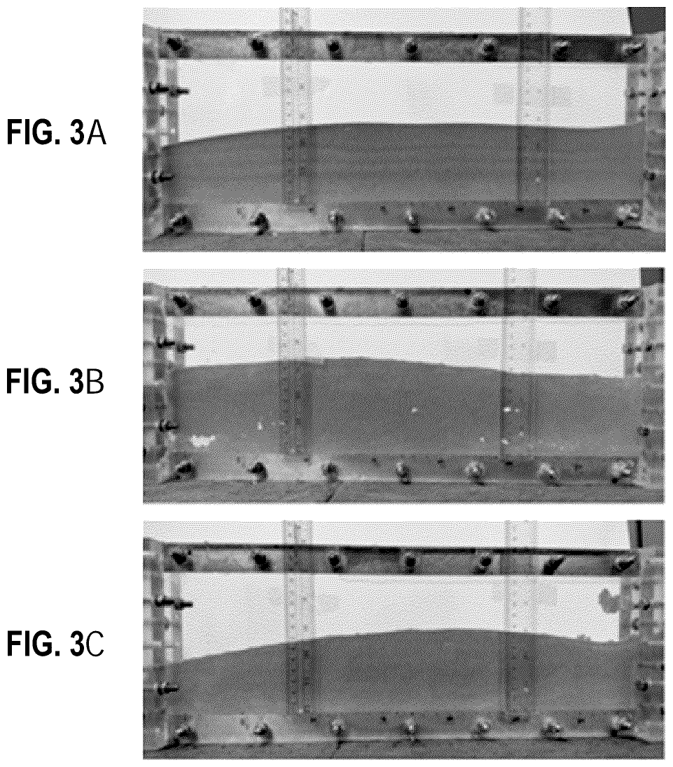

Example 2 demonstrates the formation of a filler material and evaluates its effectiveness after being pumped through a 1 mm slot. A slurry consisting of an anionic fracture reducer (added at 0.40 g/L), a cationic additive and 100-mesh sand was prepared and then pumped through the slot at a controlled rate to allow complete sand settling within the slot in a single run. The resulting settled sand bank is illustrated in FIG. 3A, FIG. 3B, and FIG. 3C.

FIG. 3A is the baseline (i.e., without cationic additive), which includes anionic friction reducer and 100-mesh sand mixed at 0.12 kg/L. FIG. 3B includes the anionic friction reducer and cationic additive (applied at 0.044 g/L) and 100-mesh sand mixed at 0.12 kg/L, showing a 21% increase in settled sand area coverage compared to the baseline. FIG. 3C is similar to FIG. 3B but with 85% of the sand concentration used in FIG. 3B (e.g., mixed at 0.102 kg/L), resulting in a 3.6% increase in settled sand coverage area compared to the baseline.

As shown in FIG. 3B, the test with 0.044 g/l of cationic additive resulted in a 21% increase in settled sand area coverage compared to the baseline case without cationic additive (as shown in a comparison between FIG. 3A and FIG. 3B). In a similar test with the same 0.044 g/l cationic additive but with sand concentration reduced to 85%, the settled sand area coverage was still 3.6% higher compared to the baseline (as shown in a comparison between FIG. 3A and FIG. 3B.

Test Conditions and Procedure for Example 2: the following steps describe the test procedure for Example 2.

1. Prepare 1 L of friction reducer solution by mixing 0.4 g of anionic friction reducer using an overhead mixer with a 3-blade marine impeller at a 1000 RPM for approximately 1 minute.

2. Measure out desired amount of 100 mesh sand, and add 0.1 ml (0.022 g/l) or 0.2 ml (0.044 g/l) of the cationic additive solution on the top of the sand, and quickly add it into the friction reducer solution.

3. Continue mixing for approximately 30 seconds, stop mixing, replace the marine impeller with a 6-blade Rushton impeller, continue mixing at 2300 RPM for 3 minutes (Rushton impeller generates a much higher shear rate than the marine impeller).

4. Transfer the slurry into the 2-L container of a dynamic proppant transport test setup, then mix the slurry at 650 RPM to keep the sand from settling.

5. Pump the slurry through a 1-mm Plexiglass slot using a peristaltic pump at a slow controlled rate to allow sand to settle within the slot.

6. Circulate the slurry through the slot until all the sand settles within the slot.

7. Let the sand settle for 30 minutes, measure the resulting sand pack height and integrate the sand coverage area.

8. Repeat steps 1-7 without adding cationic additive for baseline test.

### Example 3: Formation and Survival of Filler Material Exposed to High Temperature (300° F.) for 4 Days

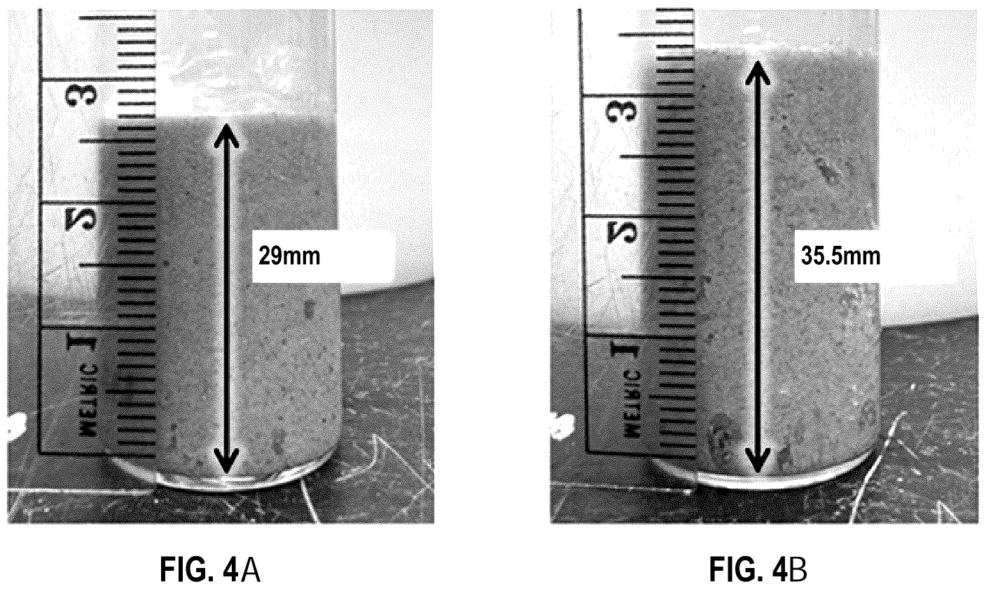

Example 3 demonstrates the formation of a filler material and assesses its resistance to high temperatures. A slurry composed of an anionic friction reducer (mixed at 0.40 g/L), a cationic additive (mixed at 0.044 g/L), and 100-mesh sand (mixed at 0.12 kg/L) was prepared, placed in a small glass vial to allow sand settling, and then exposed to a temperature of 300° F. and a pressure of 160 psi for 4 days. The sand pack formed after this process, including its stability post-exposure, is shown in FIG. 4A and FIG. 4B.

FIG. 4A illustrates the baseline slurry (i.e., without cationic additive), which includes anionic friction reducer and 100-mesh sand. FIG. 4B includes the slurry having the anionic friction reducer and cationic additive (0.044 g/L) and 100-mesh sand, showing a 22% increase in pack height compared to the baseline, which persisted after high-temperature aging. In particular, Example 3 may be compared to Example 1, above, in which the slurry mixed with the 0.044 g/L concentration of cationic additive shows the increase in pack height before being subjected to the pressure and heat of Example 3.

As seen in FIG. 4B, the sand pack resulting from the test with 0.044 g/l of a cationic additive, exposed to 300° F. and 160 psi for 4 days, was 22% higher than in the baseline test (without cationic additive) exposed to similar conditions (as shown in FIG. 4A).

Test Conditions and Procedure for Example 3: the following steps describe the test procedure for Example 3.

1. Prepare 1 L of friction reducer solution by mixing 0.4 g of anionic friction reducer using an overhead mixer with a 3-blade marine impeller at a 1000 RPM for approximately 1 minute.

2. Prepare 50 ml of cationic additive solution by adding 0.66 g of the cationic additive in 50 ml of tap water, and mix it well by stirring.

3. Measure out 60 ml of anionic friction reducer solution, pour it into a 100 ml beaker.

4. Start mixing the solution using an overhead mixer with a 0.75″ 3-blade marine impeller at 2300 RPM.

5. Measure out desired amount of 100 mesh sand, and add 0.1 ml (0.022 g/l) or 0.2 ml (0.044 g/l) of the cationic additive solution onto the sand, and quickly add it into the friction reducer solution.

6. Continue mixing for approximately 30 seconds, stop mixing, transfer slurry into a rheometer geometry test setup, then mix the slurry at an approximate RPM to generate 1600 s⁻¹ for 3 minutes.

7. Transfer all the sand and appropriate amount of fluid into a 20-ml glass vial, let it settle for 30 minutes, and measure the sand pack height in millimeters.

8. Repeat steps 3-7 to prepare baseline samples without adding cationic additive.

9. Put the samples in an aging cell, pressurize it with nitrogen to approximately 160 psi, then put the cell in an oven, and age it at 300° F. for 4 days.

10. Take out the samples from the aging cell, and measure the final sand pack height.

### Example 4: Formation of Filler Material with Varying Sand Concentrations (48 to 150 g/l)

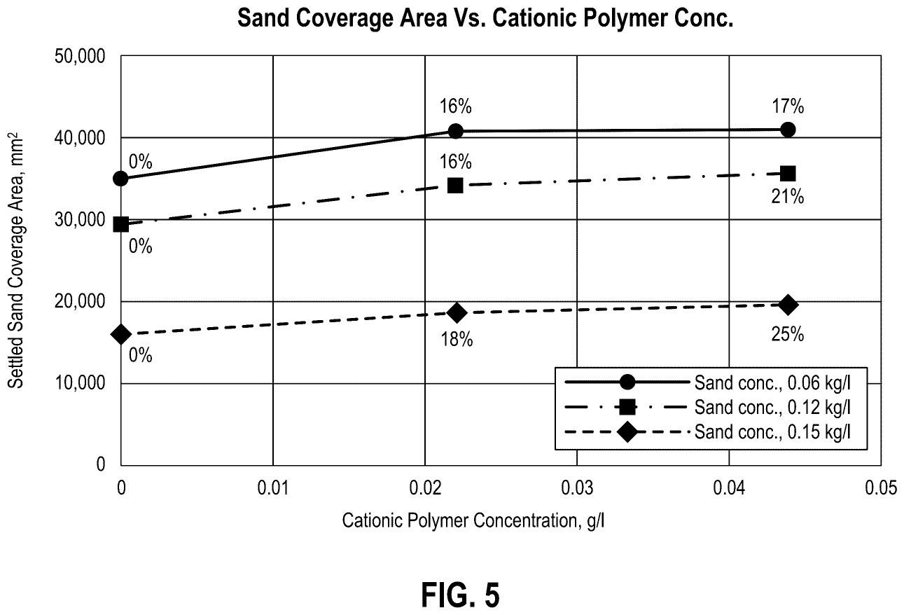

Example 4 investigates the creation and effectiveness of filler material across a range of sand concentrations. A slurry composed of an anionic friction reducer, a cationic additive, and 100-mesh sand was prepared and pumped through a 1 mm slot at a controlled rate, allowing complete sand settling in a single run. The relationship between the settled sand coverage area and the varying concentrations of cationic additive and sand is shown in FIG. 5 and detailed in Table 1 below. As seen in FIG. 5 and Table 1, the increase in settled sand coverage is consistent across the sand concentration range of 48 to 150 g/l.

Test conditions and procedure for Example 4: the following steps describe the test procedure of Example 4.

1. Prepare 1 L of friction reducer solution by mixing 0.4 g of anionic friction reducer using an overhead mixer with a 3-blade marine impeller at a 1000 RPM for approximately 1 minute.

2. Measure out desired amount of 100 mesh sand, and add 0.022 g or 0.044 g of cationic additive on the top of the sand, and quickly add it into the friction reducer solution.

3. Continue mixing for approximately 30 seconds, stop mixing, replace the marine impeller with a 6-blade Rushton impeller, continue mixing at 2300 RPM for 3 minutes (Rushton impeller can generate much higher shear rate than marine impeller).

4. Transfer the slurry into the 2-L container of a dynamic proppant transport test setup, then mix the slurry at 650 RPM to keep the sand from settling.

5. Pump the slurry through a 1-mm Plexiglass slot using a peristaltic pump at a slow controlled rate to allow sand to settle within the slot.

6. Circulate the slurry through the slot until all the sand settles within the slot.

7. Let the sand settle for 30 minutes, measure the resulting sand pack height and integrate the sand coverage area.

8. Repeat steps 1-7 without adding cationic additive for baseline test.

TABLE 1
Results of lab tests in a 1 mm slot with varied
concentrations of proppant (100-mesh sand)

| Cationic additive | Proppant (100 mesh sand) concentration, kg/l | | |
|---|---|---|---|
| concentration, g/l | 0.06 | 0.12 | 0.15 |
| 0 | 15,748 mm² | 29,661 mm² | 35,163 mm² |
| 0.022 | 18,520 mm² | 34,357 mm² | 40,900 mm² |
| | 18% propped | 16% propped | 16% propped |
| | area increase | area increase | area increase |
| 0.044 | 19,641 mm² | 35,776 mm² | 41,085 mm² |
| | 25% propped | 21% propped | 17% propped |
| | area increase | area increase | area increase |

### Example 5: Formation of Filler Material at Various Fluid Ionic Strengths

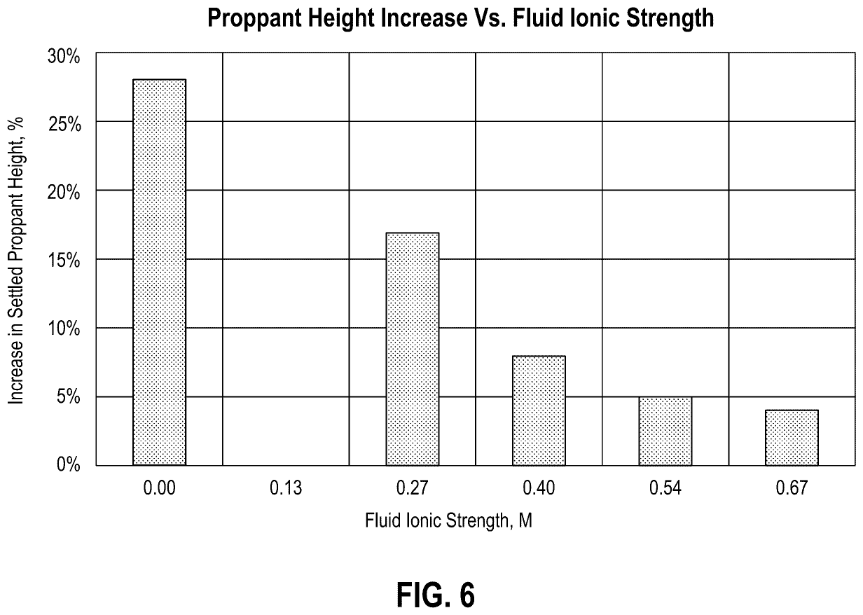

Example 5 demonstrates the formation and effectiveness of filler material in fluids with varying ionic strengths as illustrated in FIG. 6. The results show that the increase in pack height remains significant up to an ionic strength of 0.67 M, although the magnitude of the increase diminishes as the ionic strength rises.

Test Conditions and Procedure for Example 5: the following steps describe the test procedure for Example 5.

1. Measure out 0.08 g of an anionic friction reducer and appropriate amount of potassium chloride (KCl), add them to 200 ml of tap water in a beaker to make friction reducer solution with desired ionic strength.

2. Mix the solution using an overhead mixer with 3-blade marine impeller at 1000 RPM for 1 minute.

3. Measure out 48 g of 100 mesh sand, and add an appropriate amount of cationic additive on the top of the sand to achieve a desired cationic concentration, and quickly add it into the friction reducer solution.

4. Continue mixing for 60 seconds, stop mixing, and transfer the slurry into a 250-ml graduated cylinder.

5. Let it settle for 30 minutes, and measure the final sand pack height in millimeters.

6. Repeat steps 1-5 to prepare baseline sample without adding cationic additive.

Fluid ionic strength was adjusted by dissolving KCl. Water solution KCl at 5 wt % corresponds to the ionic strength 0.67 M.

### Example 6: Survival Of Filler Material Exposed To High Pressure And High Temperature

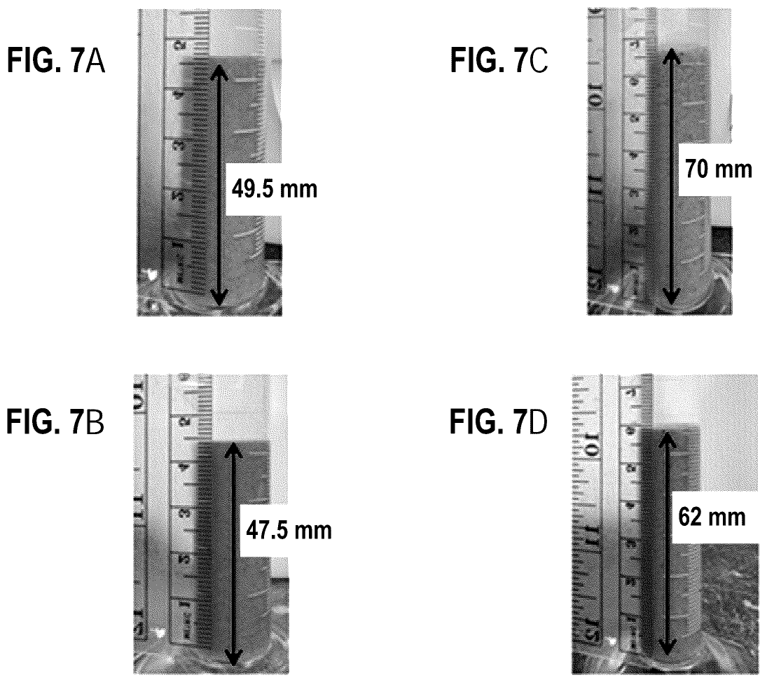

Example 6 demonstrates the formation of a filler material and evaluates its resistance to high pressure and temperature. A slurry composed of an anionic friction reducer (mixed at 0.42 g/L), a cationic additive (mixed at 0.011 g/L), and 100-mesh sand (mixed at 0.12 g/L) was prepared at ambient conditions. The slurry was placed in a glass vial to allow sand settling and subsequently aged at 240° F. and 5,000 psi for 24 hours. The resulting sand packs, including their stability after exposure, are shown in FIG. 7A through FIG. 7D.

FIG. 7A and FIG. 7C illustrate settled sand packs before ageing. The sample illustrated in FIG. 7A and FIG. 7B contains anionic friction reducer and sand. The sample illustrated in FIG. 7C and FIG. 7D contains anionic friction reducer, cationic additive, and sand. The samples illustrated in FIG. 7B and FIG. 7D are the corresponding packs after ageing at 5,000 psi and 240° F. for 24 hours. The results indicate that the filler effect persists after exposure to an applied pressure of 5,000 psi and a temperature of 240° F.

### Procedure for Example 6:

1. Prepare the sample illustrated in FIG. 7C by dissolving 0.0252 g of dry anionic friction reducer in 60 ml of fresh water for 60 seconds using an overhead mixer.

2. Weigh 7.2 g of 100-mesh sand and 0.00066 g of cationic additive. Add them to the solution prepared in Step 1 while mixing. Mix for 3 minutes.

3. Transfer the slurry into a graduated cylinder.

4. Allow the slurry to stand for 30 minutes to enable sand settling. Record the settled sand pack height.

5. Prepare the sample illustrated in FIG. 7A by repeating Steps 1-4 without the addition of the cationic additive.

6. Place the sample illustrated in FIG. 7A and the sample illustrated in FIG. 7C in a high-temperature, high-pressure curing chamber and condition at 5,000 psi and 240° F. for 24 hours.

7. Release the pressure, remove the samples from the curing chamber, cool them to ambient temperature, and measure the settled sand pack heights.

### Example 7: Pack Clean-Up Performance

Example 7 demonstrates that sand packs prepared with the filler material can be effectively cleaned under simulated bottomhole conditions and can achieve conductivity values comparable to, or in some cases higher than, those obtained with slickwater or KCl brine.

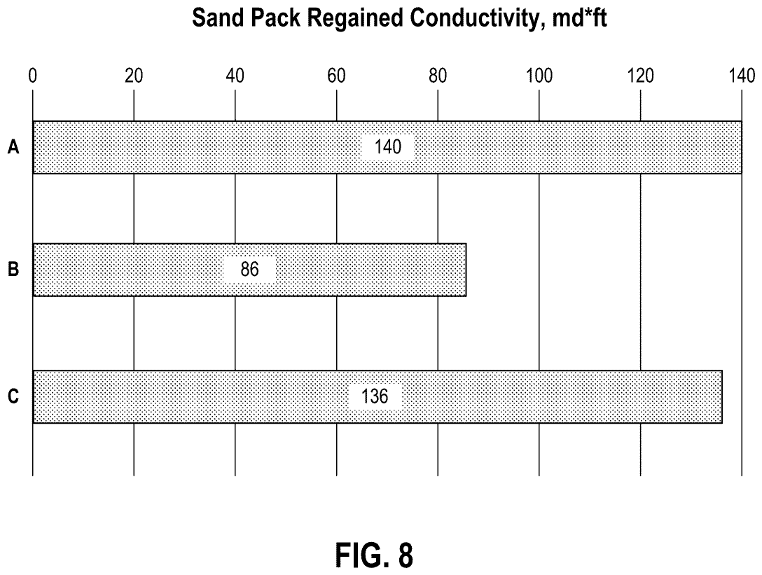

FIG. 8 illustrates regained conductivity of sand packs (measured in md.ft) using an API conductivity cell at 220° F. and 6,000 psi closure stress. The sand packs were prepared with 40/70 Northern White sand in three carrier fluids:

Sample A: 7% KCl brine.

Sample B: slickwater containing an anionic friction reducer at 0.42 g/l.

Sample C: slickwater containing an anionic friction reducer at 0.42 g/l and a cationic additive at 0.022 g/l (filler material).

In all cases, the proppant slurries were prepared and loaded into the cell at ambient temperature and pressure at a loading of 1 lb/ft², pressed between Ohio Sandstone cores, and conditioned under stress before undergoing clean-up with 7% KCl brine for 50 hours.

Procedure for Example 7:

1. Prepare Ohio Sandstone cores in accordance with API RP 19D specifications.

2. Load the proppant slurry into the conductivity cell at a concentration of 1 lb/ft².

3. Use 40/70 Northern White proppant (Covia) for all Samples A-C.

4. Apply closure stress of 1,000 psi at a rate of 100 psi/min and hold for 1 hour.

5. Increase temperature to 220 DegF and maintain for 24 hours.

6. Increase closure stress to 6,000 psi at a rate of 100 psi/min and hold for 4 hours.

7. Reduce closure stress to 5,000 psi at a rate of 100 psi/min and hold for 4 hours.

8. Reapply closure stress of 6,000 psi at a rate of 100 psi/min and maintain for 24 hours.

9. Perform a clean-up sequence with 7% KCl brine using the staged flow rates presented below in Table 2 to simulate flowback.

TABLE 2

| Flow Rate (mL/min) | Duration (hours) |
|---|---|
| 0.5 | 0.5 |
| 1.0 | 0.5 |
| 2.0 | 19.0 |
| 4.0 | 2.0 |
| 8.0 | 1.0 |
| 2.0 | 25.0 |

10. Following the clean-up sequence, measure conductivity according to standard API procedures.

### Example 8: Effect of Filler Material on Friction Reduction Performance

Example 8 demonstrates that the formation of a filler material does not negatively impact the friction-reducing performance of slickwater fluid.

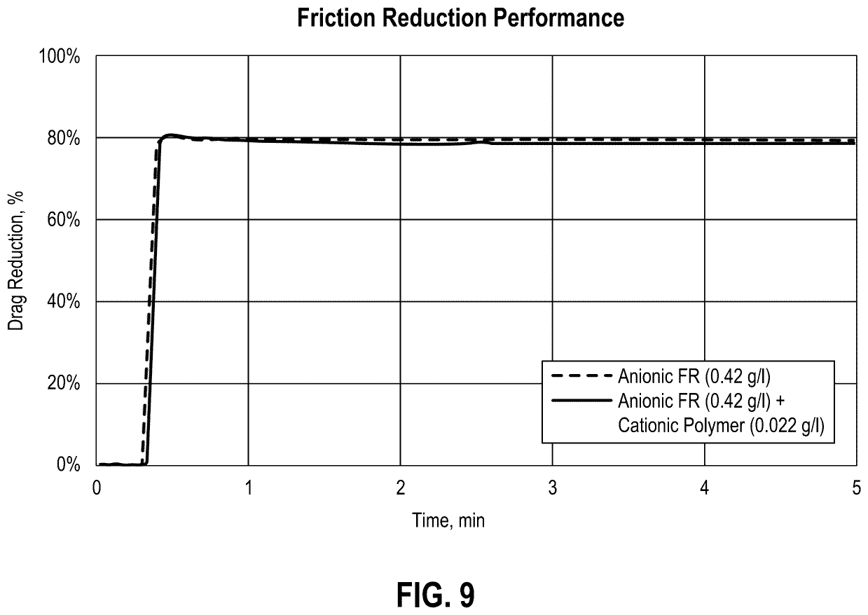

FIG. 9 shows friction reduction curves (percent reduction in pressure drop compared to fresh water) for slickwater containing an anionic friction reducer with and without the filler material. The curves nearly overlap, indicating that the presence of the filler material does not adversely affect friction reduction performance.

### Procedure for Example 8

The test was performed at 70 DegF using a friction loop composed of ¾-inch OD Swagelok tubing equipped with valves and pressure sensors.

1. Prepare the cationic additive solution by mixing 0.31 g of cationic additive with 20 ml of fresh water.

2. Fill the friction loop with 14 L of fresh water and circulate at a rate of 63 kg/min.

3. While circulating, introduce the cationic additive solution prepared in Step 1 into the friction loop.

4. Begin data acquisition and record baseline pressure drop data for 25 seconds.

5. Add 5.88 g of dry anionic friction reducer into the friction loop and continue circulating for 5 minutes.

6. For the control test without the cationic additive, repeat Steps 2-5 without introducing the cationic additive.

7. Calculate drag reduction at each time interval using the standard drag reduction equation.

8. Compare drag reduction values between the additive-containing and additive-free tests to evaluate the impact of the filler material on friction-reducing performance.

### Example 9: Effect of Filler Material on Slickwater Viscosity

Example 9 demonstrates that the formation of a filler material does not significantly affect the viscosity of slickwater fluids.

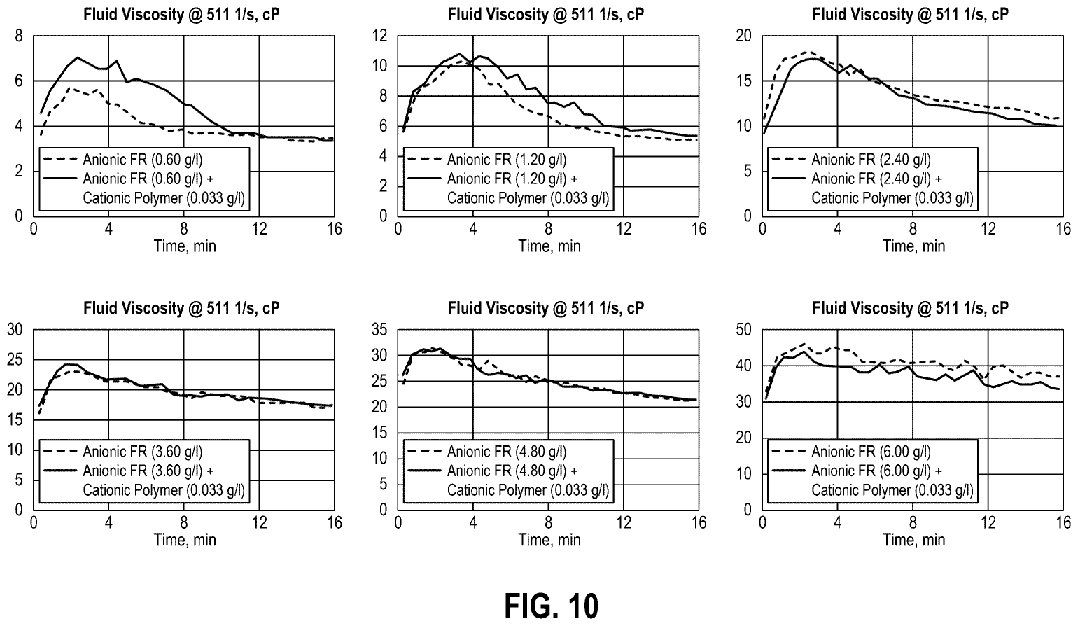

Fluid viscosity development measured at 511 s⁻¹ and 170° F. for slickwater fluids containing anionic friction reducer (FR) at concentrations ranging from 0.6 g/l to 6.0 g/l, with and without a cationic additive at 0.033 g/l. Graphs a-f of FIG. 10 correspond to increasing FR concentrations: (a) 0.6 g/l, (b) 1.2 g/l, (c) 2.4 g/l, (d) 3.6 g/l, (e) 4.8 g/l, and (f) 6.0 g/l. As illustrated in FIG. 10, the results indicate that the effect of the cationic additive on viscosity profiles is minor-generally less than 15%, which is within the accepted experimental error margin for this type of viscosity measurement. No consistent trend was observed, indicating that viscosity values with and without the cationic additive are essentially equivalent. Indeed, it is important to note that no change in viscosity values indicates that the addition of the cationic additive provides no or limited impact on the fluid transport performance of the slickwater slurry.

### Procedure for Example 9:

Viscosity was measured using a Grace M3600 rheometer under the following conditions:
Shear rate: 511 s⁻¹
Temperature: 170 DegF

The procedure was as follows:

1. Measure 250 ml of fresh water and transfer into a 600-ml beaker.

2. Add the required amount of dry friction reducer while mixing with a marine propeller and an overhead mixer at 1500 RPM.

3. Continue mixing for 20 seconds, then add the cationic additive and continue mixing for an additional 10 seconds.

4. Measure viscosity as a function of time.

5. Repeat Steps 1-4 for a sample without the cationic additive.

6. Compare viscosity profiles for fluids with and without the cationic additive.

The specific embodiments described above have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A method for creating a filler material in a slickwater slurry for fracturing operations:
adding a cationic additive to the slickwater slurry, wherein the cationic additive is configured to interact with a friction reducer upon addition, thereby forming one or more gel-like substances or agglomerates.

2. The method of claim 1, wherein the cationic additive comprises:
polyaziridines, polyethylene iminoacetate, or modified polyethyleneimines (including PEGylated polyethyleneimine, alkylated polyethyleneimine, and cross-linked polyethyleneimine), cationic polyacrylamides, copolymers with an acrylamide and a cationic comonomer, biopolymers with cationic functionalization, or a combination thereof.

3. The method of claim 1, wherein the cationic additive has a molecular weight between approximately 50,000 Daltons to 5,000,000 Daltons, inclusive.

4. The method of claim 1, wherein the cationic additive has a concentration between approximately 0.01 to 0.5 g/L, inclusive.

5. The method of claim 1, wherein the cationic additive is added before, simultaneously, or after the addition of the friction reducer or any other components of the slickwater slurry.

6. The method of claim 1, wherein the cationic additive is added at surface or through a separate line downhole.

7. The method of claim 1, wherein the filler material, once formed, is configured to retain its functionality after exposure to a shear rate up to 1,600 sec⁻¹ for at least 3 minutes.

8. The method of claim 1, wherein the filler material retains its functionality after being placed downhole and exposed to temperatures up to 300° F. for at least 4 days.

9. The method of claim 1, wherein proppant size is between approximately 37 microns (400 mesh) to approximately 2 millimeters (mesh 10), inclusive.

10. The method of claim 1, wherein the filler material is effective at proppant concentrations between approximately 12 to approximately 1,200 gram per liter of added fluid.

11. The method of claim 1, wherein the filler material is effective at proppant concentrations between approximately 60 to approximately 240 gram per liter of added fluid.

12. A method for enhancing proppant distribution within a fracture system, comprising:
forming one or more agglomerates or one or more aggregates in a slickwater slurry, the one or more agglomerates or the one or more aggregates acting as filler material in a sand pack;
wherein the filler material is formed by adding a cationic additive to the slickwater slurry, wherein the cationic additive is configured to react with friction reducer in the slickwater slurry upon addition, thereby forming the one or more agglomerates or the one or more aggregates.

13. The method of claim 12, wherein the filler material is configured to reduce bulk density of the sand pack and increase a height of the sand pack for a given mass of sand after the sand is placed in the fracture system.

14. The method of claim 12, wherein the cationic additive comprises:
polyaziridines, polyethylene iminoacetate, or modified polyethyleneimines (including PEGylated polyethyleneimine, alkylated polyethyleneimine, and cross-linked polyethyleneimine), or a combination thereof.

15. The method of claim 12, wherein the cationic additive is added before, simultaneously, or after the addition of the friction reducer or any other components of the slickwater slurry.

16. The method of claim 12, wherein the cationic additive is added at surface or through a separate line downhole.

17. The method of claim 12, wherein the filler material, once formed, is configured to retain its functionality after exposure to a shear rate up to 1,600 sec⁻¹ for at least 3 minutes.

18. The method of claim 12, wherein the filler material retains its functionality after being placed downhole and exposed to temperatures up to 300° F. for at least 4 days.

19. The method of claim 12, wherein the filler material is effective at proppant concentrations between approximately 12 to approximately 1,200 gram per liter of added fluid.

20. The method of claim 12, wherein the filler material is effective at proppant concentrations between approximately 60 to approximately 120 gram per liter of added fluid.
